(19) United States
(12) Patent Application Publication
(10) Pub. No.: US 2005/0236801 A1
(43) Pub. Date: Oct. 27, 2005

(54) Body weight-activated scooter

(76) Inventor: Yair Tal, Kfar Saba (IL)

Correspondence Address: Edward Langer;c/o Shiboleth, Yisraeli, Roberts, Zisman & Co., 60th Floor, 350 Fifth Avenue, New York, NY, 10118, US

(21) Appl. No.: 11/108,075

(22) Filed: Apr. 18, 2005

Related U.S. Application Data
(60) Provisional application No. 60/563,830, filed on Apr. 21, 2004.

(51) Int. Cl. B62M 1/00

(52) U.S. Cl. 280/221

(57) ABSTRACT

A body weight-activated scooter operated by the weight of the body through small, controlled, foot movements. The scooter has at least one front wheel and at least one rear wheel attached on a frame, with a foot-rest pivotally attached at its forward portion to a fixed point on the frame and fixedly attached at its heelward portion to one end of a linking means so that the heelward portion of the foot-rest is free to pivot up and down. The scooter has a drive train mounted on the frame comprising a weight-vector wheel connected to an overrunning clutch-drive which is mechanically connected to the rear wheel, the overrunning clutch-drive providing sustained forward thrust when the foot-rest is depressed, thus activating the drive train via the linking means to produce forward motion. The linking means is firmly attached at its other end to a return tension means attached to the frame, enabling continuous, repetitive scooter operation.

### FIELD OF THE INVENTION

The present invention relates generally to scooters, and more particularly to a body weight-activated scooter utilizing the principle of an overrunning clutch drive for generating forward motion.

### BACKGROUND OF THE INVENTION

The world population, especially in Western societies, resides more and more in flat, smooth places (due to paving). Localities and areas that are not smooth and flat can be improved and developed into areas more suitable to the use of “wheeled feet”, to ease the task of the feet.

Lightweight, relatively inexpensive, small-wheeled, foot-operated devices for individual transport, recreation, and sports activity--exclusive of pedaled vehicles, such as bicycles—generally include scooters, skateboards, roller skates, and roller blades which are generally used by young children and youth. While the former two devices are operated with a foot action, pushing with a foot against a hard surface to create an opposing forward motion, the latter two devices are strapped directly to the feet of a user and are operated by combinations of foot and body action, similar to rapid walking performed with a swaying motion of the upper portion of the body, an activity generally unsuitable for older adults and elderly people with reduced physical abilities.

Thus there is a need for a relatively inexpensive, lightweight, yet sturdy-construction scooter which can support an adult user without undue physical exertion and which is activated by the use of body-weight force.

### SUMMARY OF THE INVENTION

Accordingly, it is a principal object of the present invention to overcome the disadvantages of the prior art and to provide a body weight-activated scooter having at least one front wheel and at least one rear wheel attached on a frame, the scooter comprising:
at least one foot-rest pivotally attached at its forward portion to a fixed point on the frame and fixedly attached at its heelward portion to one end of a linking means so that a heelward portion of the at least one foot-rest is free to pivot up and down, and
at least one drive train mounted on the frame for operation of the scooter, the at least one drive train comprising:
at least one weight-vector wheel for controlled timing of forward motion of the scooter, and
at least one overrunning clutch-drive connected to the at least one weight-vector wheel, the at least one overrunning clutch-drive providing sustained forward thrust,
wherein when the at least one foot-rest is depressed by the body-weight force of a rider, the at least one drive train is activated via the linking means to produce the forward motion, the at least one overrunning clutch-drive being mechanically connected to the at least one rear wheel, the at least one linking means being firmly attached at its other end to at least one return tension means attached to the frame to enable continuous repetition of the operation of the at least one drive-train.

The scooter of the present invention, in a preferred embodiment thereof, is operated by the weight of the body through small, controlled, foot movements, either individually or together, which, when applied to at least one foot-rest or foot-supporting belt, moves the scooter forward. In effect, the scooter exploits the weight of the body while “walking” in place to generate a forward motion. When a user pauses between “steps”, the scooter coasts freely. To lengthen coasting motion, the user simply resumes the “walking” action and it is not necessary to use a push with a free foot against the ground or surface to regain momentum as is done with a children's scooter. The scooter is especially suited for use on flat, paved areas, such as city streets, sidewalks, broad plazas, and shopping and recreational centers since it is not motorized.

In a preferred embodiment of the invention, one side of a link-chain is connected to the heel portion of a foot-rest or foot-supporting belt; the second side of the link-chain is connected to an overrunning clutch, which operates at least one rear-drive wheel. The purpose of the overrunning clutch is to operate the drive-train which is automatically engaged in one direction, but freewheels in the other. A return spring returns the link-chain to its initial starting position.

Alternatively, a V-belt is used in place of a link-chain to operate the overrunning clutch. The tightness of the V-belt or link-chain allows a twofold pull and consequent saving of energy in the propulsion of the scooter. This allows for a higher speed of operation and reduced weight of the frame. In a preferred embodiment of the invention, the foot-rests are provided with skid-proof surfaces for greater traction. Alternatively, lighter-weight foot-supporting belts are provided instead of foot-rests for operating the scooter and resting the feet.

The system of the invention is adaptable for application in a four-wheeled chassis having two drive-wheels for the convenience of adults and people with physical limitations. It can also be used as a sports or recreational vehicle having two wheels, mounted at opposing ends of the dual foot-rest, one of which is a drive fitted with two overrunning clutches mounted one on each side of the drive-wheel and the other a freely-turning wheel to provide steering. In one embodiment of the invention, the device fits under a foot much like a skate shoe with an open heel. With the aid of intermediate wheels one can align a linking means, such as a link-chain above and behind the heels of the feet.

The invention is adaptable to accommodate add-ons to assist easy and correct movement of a link-chain in a number of ways, such as the addition of an idler wheel to reduce slack in the link-chain. Other add-ons, such as front and rear lights, warning lights and alarms, a speedometer, and an odometer are easily fitted to the scooter of the invention. Furthermore, small, relatively quiet, electric drives or motors can be added, for example, to automatically and more comfortably adjust the height of either the handlebars or the weight-vector wheels for different users and for different applications of the scooter of the invention.

An appropriate frame, as lightweight as possible, is necessary to optimize the stepping action of a user to drive the scooter forward. In a preferred embodiment of the invention, the scooter is constructed of a relatively lightweight material, such as plastic, aluminum, leather, and any similar lightweight structural material so it is convenient to use and saves exertion effort of a user.

The stepping action can be extended or shortened as needed by changing the height of the weight-vector wheel in relation to the ground and thus optimizing the placement of the body weight for maximizing either the power or speed of the scooter. The low center of gravity of the scooter provides for greater stability and control for users.

The scooter is intended for smooth, flat surfaces which will help people who have walking difficulties; only a small lifting of the heel of the foot is sufficient to create a driving “pulse”. The device of the invention, being simple in design, does not require a motor and is therefore relatively inexpensive to produce. It is also quiet in operation and pollution-free to the environment.

The key element of locomotion is the requirement that the pushing vector is optimized in relation to the gravitational vector so as to utilize the lowest center of gravity. The power of the foot pressure is applied as close as possible to the pressure vector. In a sports model embodiment of the invention, the pressing cycle is longer than in other applications.

The present invention, in a preferred embodiment thereof, optimizes the placement of the foot-rest close to the ground, thus providing the added advantage that it is easier for elderly users to alight or mount the scooter.

Other features and advantages of the invention will become apparent from the following drawings and descriptions.

### BRIEF DESCRIPTION OF THE DRAWINGS

For a better understanding of the invention in -regard to the embodiments thereof, reference is made to the following drawings, not shown to scale, in which numerals designate corresponding sections or objects throughout, and in which:

FIG. 1 is a schematic drawing of the initial stage of operation of components of the power train system of the invention in a preferred embodiment thereof,

FIG. 2 is a schematic drawing of the return stage of operation of the power train system from FIG. 1;

FIG. 3 is a top, schematic view of the layout, in accordance with a preferred embodiment of the invention, of the major components of a two-wheeled scooter adapted for sport users;

FIG. 4 is an exploded, detailed view of the embodiment of the two-wheeled scooter of FIG. 3;

FIG. 5 is top, schematic view of the layout, in accordance with another embodiment of the invention, of the major components of a four-wheeled scooter suitable for adult and recreational use;

FIG. 6 is an exploded, diagrammatic view of the embodiment of the four-wheeled scooter of FIG. 5; and

FIGS. 7a and 7b are side views illustrating the initial and return stages, respectively, in the operation of yet another embodiment of the invention.

### DETAILED DESCRIPTION OF THE INVENTION

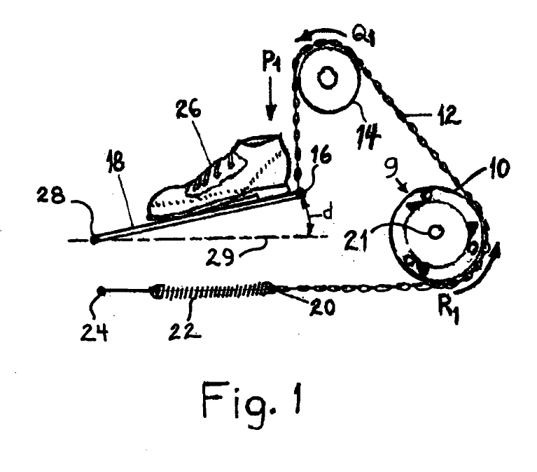

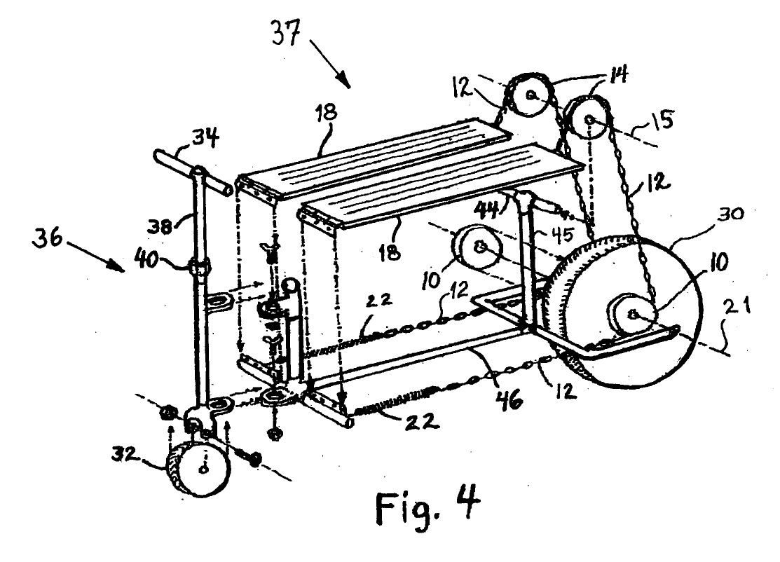

FIG. 1 is a schematic drawing of the initial stage of operation of components of the power train system of the invention in a preferred embodiment thereof. Since FIG. 1 is intended to illustrate only the power train system of the invention, the wheels, frame, and steering mechanisms of a scooter, which are known to those skilled in the art, are not shown (see FIG. 4).

One end of a linking means 12, such as a bicycle-type link-chain or, alternatively, a V-belt, is attached at a node 16 to a foot-rest 18 which is rotatably attached at a forward node 28 of foot-rest 18, such as by a hinge, so that the heelward portion of foot-rest 18 near node 16 is free to move up and down with the corresponding movement of link-chain 12.

For convenience of description and for illustration purposes, linking means 12 is hereinafter referred to as link-chain 12.

Link-chain 12 is linked to a weight-vector wheel 14 disposed above foot-rest 18, then passes around and connects to an overrunning clutch 10, and finally is secured at node 20 to return spring 22 which itself is fixedly connected at node 24 to a scooter frame (not shown). Forward node 28 is also mechanically connected to another part of the same frame. An overrunning clutch will automatically engage in one direction, but will freewheel in the other. In a preferred embodiment of the invention and by way of example, the overrunning clutch 10 is of the roller bearing type. The general symbols 9 represent a sampling of one of a number of roller bearings and ramps which are housed in an inner hub of overrunning clutch 10 and which allow movement of the roller bearings in only one direction (up the ramp), but acts as a stop in the other direction causing the clutch to freewheel.

Body-weight force of a user, represented by shoe 26, operates the power train system of the invention to produce forward motion. Stepping action on foot-rest 18 creates “pulses” which rotate overrunning clutch 10 and moves link-chain 12, as shown in FIG. 1 by arrows. The drive pulse is transmitted to at least one rear-drive wheel, indicated by the common axle 21, when an incremental downward movement of the heel of a rider standing on at least one foot-rest 18 exerts foot pressure on the drive train. Thus, a downward pressure (indicated by arrow P1) at the heel of shoe 26 on foot-rest 18 causes link-chain 12 to also move downward and counter-clockwise (arrow Q1) around weight-vector wheel 14 thus rotating (arrow R1) overrunning clutch 10 and providing thrust to at least one rear-drive wheel (not shown) attached to it through the common axle 21, providing a forward motion to propel the scooter.

The counter-clockwise motion about weight-vector wheel 14 and overrunning clutch 10 of link-chain 12 pulls and extends return spring 22 creating a tension force. When foot-rest 18 reaches a pre-determined arc of motion d, it comes to rest at stopping position 29. This arc of motion d is adjustable in accordance with the optimal functioning of the system of the invention and releases the pressure on overrunning clutch 10 which then freewheels, as explained heretofore.

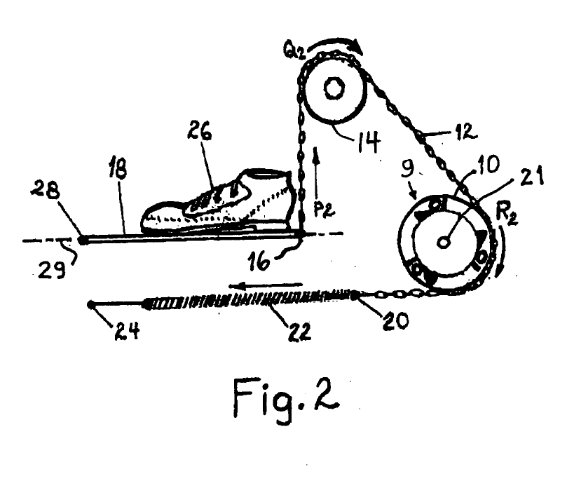

FIG. 2 is a schematic drawing of the return stage of operation of the power train system shown in FIG. 1. Overrunning clutch 10 is forced by the tension of return spring 22 to freewheel in a reverse, clockwise direction R2, thus returning return spring 22 to a state of rest while not producing any forward motion. Link-chain 12, however, is drawn upward (as indicated by arrow P2) at node 16 to wind clockwise (arrow Q2) around weight-vector wheel 14, thus lifting the heelward portion of foot-rest 18 upward into a ready position for another cycle of operation of the power train.

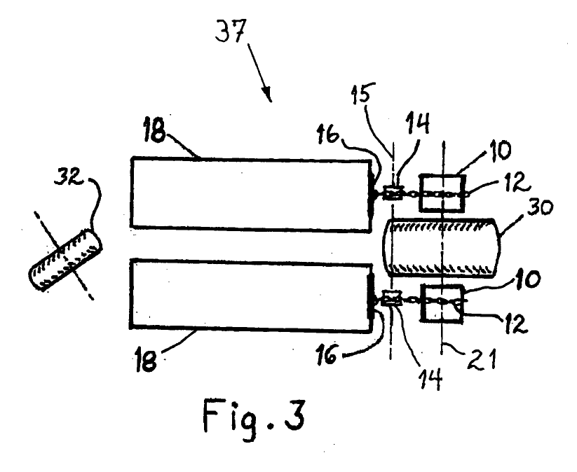

FIG. 3 is a top, schematic view of the layout of the major components of a two-wheeled scooter adapted for sport users and constructed in accordance with a preferred embodiment of the invention. The scooter 37 is shown in a schematic type view without reference to a frame or steering means to emphasize the inventive features.

One rear-drive wheel 30 is disposed on the same axle, represented by center line 21, as a pair of overrunning clutches 10 which are mounted on both sides of rear wheel 30 and linked by link-chain 12 to a pair of weight-vector wheels 14 mounted on a common axis 15 supported by a vertical frame shaft (not shown) above twin foot-rests 18. A steerable front wheel 32 is shown in FIG. 3 only for reference purposes in relation to the other described features in the layout of the invention.

FIG. 4 is an exploded, detailed view of the embodiment of the two-wheeled scooter of FIG. 3. The scooter 37 is guided by handlebars 34 and turning post 36 connected by a height adjustment shaft 38 to front wheel 32. A tightening means 40 is provided to hold the handlebars 34 at a designated height suitable for the user. The entire steering mechanism 36, from handlebars 34 to front wheel 32 can be disassembled as shown in FIG. 4 for convenient storage of the scooter using standard mechanical fasteners, such as are well-known to those skilled in the art. Dot-and-dash lines are used to indicate re-assembly points and directions for attachment of the various components shown.

To provide maximum body-weight vector force, a T-bar 44 is connected to the scooter frame 46 via a vertical frame shaft 45 which can be varied in height to provide for differences in body-weight vector forces and optimize scooter performance by altering the center of gravity in relation to the body weight of a user. Controlled timing, by adjusting the gravity vector of the weight vector-wheel 14, affects a change in the speed of travel and power of motion of a scooter.

Forward motion is optimized when the foot pressure applied by a user is as close as possible to the pressure vector in relation to a gravitational vector. The weight-vector wheels 14 are mounted on either side of T-bar 44 and linked by link-chain 12 to their respective overrunning clutches 10 disposed on the outer sides of rear drive-wheel 30.

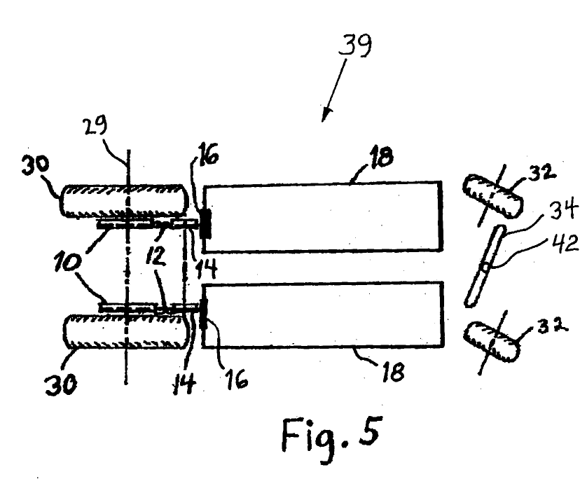

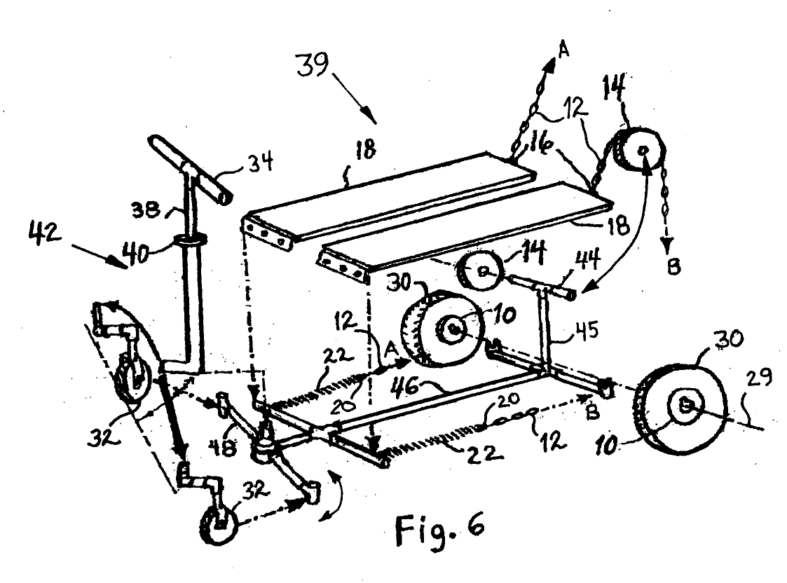

FIG. 5 is top, schematic view of the layout, in accordance with another embodiment of the invention, of the major components of a four-wheeled scooter suitable for adult and recreational use. (Additional features and further details are shown in FIG. 6.)

The four-wheeled scooter 39 is provided with two overrunning clutches 10, which are mounted on a common axle 29 with two fixed rear-drive wheels 30 to which they are mechanically connected. A pair of linking means, such as link-chains 12 are fixedly connected at nodes 16 to respective foot-platforms 18 and engage a pair of weight-vector wheels 14, which are mounted on a supporting frame structure (not shown) above each respective foot-rest 18 and further linked to corresponding overrunning clutches 10. After being partially wound around their respective overrunning clutches 10, each of the other ends of each link-chain 12 are fixedly attached to return tension means, such as tension springs (not shown) which are anchored in the underside of the frame (not shown) of scooter 39. The principle of operation of scooter 39 is as shown in FIGS. 1 and 2 and described hereinbefore. Two, steerable front wheels 32 for steering are controlled by handlebars 34 attached to a steering means 42 (see FIG. 6).

FIG. 6 is an exploded, detailed view of the embodiment of the four-wheeled scooter of FIG. 5. In most respects, scooter 39 operates similarly to the embodiment of the invention of FIGS. 3 and 4 except for the distinctive feature of additional wheels and a more sophisticated steering mechanism 42, including a turn-bar mechanism 48 as is known to those skilled in the art for operating both front wheels 32 in tandem when making a turn with scooter 39. It should be noted that in actual assembly, the weight-vector wheels 14 are aligned above their respective rear-drive wheels 30 so that each, respective link-chain 12 is linked without slack around their respective overrunning clutches 10 to apply maximum torque to rear-drive wheels 30 when scooter 39 is operated. Due to the exploded view shown in FIG. 6, the two link-chains 12 are not shown in full, but only partially shown at their respective ends where they are fixed at nodes 16 and 20 and arrows A-A and B-B indicate general continuations from end to end. A full, detailed layout of the link-chain connections is as shown in FIGS. 1 and 2 for each rear-drive wheel 30.

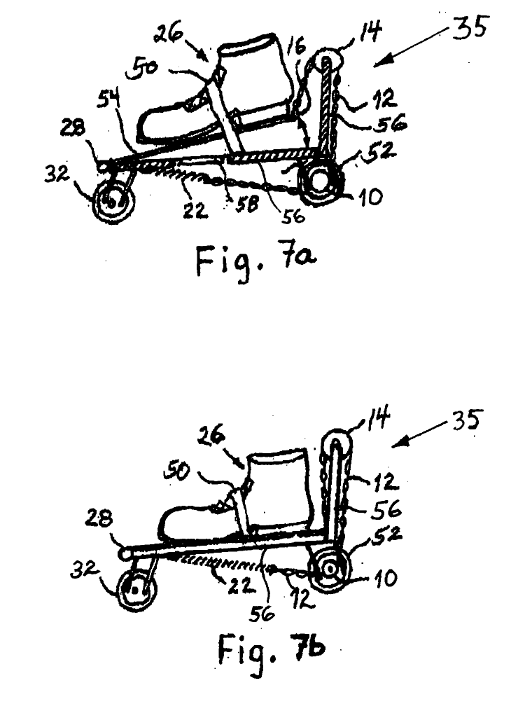

FIGS. 7a and 7b are side views illustrating the initial and return stages, respectively, in the operation of yet another embodiment of the invention.

The overrunning clutch principle is applied to a self-propelled roller-skate type device 35 attached by a foot strap 50 to each shoe 26 of a user. In another embodiment of the invention (not shown), a shoe-like platform is an oversized, fixed feature which conveniently accommodates and holds a variety of user shoe sizes. In either embodiment, the foot of the user is strapped tightly to a shoe platform 54 or, alternatively, to a wide, foot-supporting belt (not shown) which replaces platform 54. The belt embodiment of the invention is provided with a small-diameter rod or wheel disposed at the heel end of shoe 26 to maintain tension in the belt and control slack.

In operation, as shown in FIG. 7a, the user's foot in shoe 26 presses down so that the heel of shoe 26 moves in a short arc downward as shown by the double-headed arrow. The link-chain 12 is thus pulled in a downward direction by body weight force applied via link-chain 12 to weight-vector wheel 14 which rotates counter-clockwise. Since weight-vector wheel 12 is linked to overrunning clutch 10 mounted on the axle of rear-drive wheel 52, the overrunning clutch 10 also rotates counter-clockwise and causes rear-drive wheel 52 to also turn, moving device 35 forward. When the foot of a user comes to rest at the lowest point of the arc designated in FIG. 7a by the double-headed arrow, the return tension spring 22 is fully stretched and begins to exert a counter-pulling force on link-chain 12. Since this force causes overrunning clutch 10 to rotate in a clock-wise direction, it becomes disengaged from rear-drive wheel 52 and freewheels. When the heel of a user is raised away from shoe platform 54 at the downward end of a “walking” cycle as indicated in FIG. 7b, shoe platform 54 becomes free to rise at its heelward end due to the reverse pull on link-chain 12 generated by tension spring 22 on link-chain 12 and this prepares the roller-skate type device 35 for another cycle of operation.

A rigid structure 56 both supports weight-vector wheel 14 disposed at an optimal height above shoe platform 54 to maximize body-weight force and provides a frame for the roller-skate type device 35. Rigid structure 56 is made of rigid plastic although other suitable materials may be used. Notice the cutaway view of rigid structure 56 in FIG. 7a which shows a metal support 58 embedded in the frame to provide greater safety and strength.

Having described the invention with regard to certain specific embodiments, it is to be understood that the description is not meant as a limitation, since further modifications may now suggest themselves to those skilled in the art, and it is intended to cover such modifications as fall within the scope of the appended claims.

1. A body weight-activated scooter having at least one front wheel and at least one rear wheel attached on a frame, said scooter comprising:
at least one foot-rest pivotally attached at its forward portion to a fixed point on said frame and fixedly attached at its heelward portion to one end of a linking means so that said heelward portion of said at least one foot-rest is free to pivot up and down, and
at least one drive train mounted on said frame for operation of said scooter, said at least one drive train comprising:
at least one weight-vector wheel for controlled timing of forward motion of said scooter, and
at least one overrunning clutch-drive connected to said at least one weight-vector wheel, said at least one overrunning clutch-drive providing sustained forward thrust,
wherein when said at least one foot-rest is depressed by the body-weight force of a rider, said at least one drive train is activated via said linking means to produce said forward motion, said at least one overrunning clutch-drive being mechanically connected to said at least one rear wheel, said at least one linking means being firmly attached at its other end to at least one return tension means attached to said frame to enable continuous repetition of said operation of said at least one drive-train.

2. The scooter of claim 1 further comprising a steering means provided for said at least one front wheel.

3. The scooter of claim 1 wherein said at least one linking means is provided with at least one idler wheel to reduce slack in said at least one linking means.

4. The scooter of claim 1 wherein said foot-rest comprises dual platforms mounted side by side on said frame.

5. The scooter of claim 1 wherein said foot-rest comprises a pair of twin platforms mounted on separate units comprising said frame.

6. The scooter of claim 5 wherein each of said pair of twin platforms comprises shoe-rests to separately accommodate the shoes of a user.

7. The scooter of claim 5 wherein each of said pair of twin platforms comprises an oversized shoe-like platform which accommodates and holds a variety of user shoe sizes.

8. The scooter of claim 6 wherein said shoe-rests comprise at least one foot-supporting belt having a wide surface adaptable to accommodate the shoes of a rider.

9. The scooter of claim 8 wherein said at least one foot-supporting belt is provided with a small-diameter rod disposed at the heel end of a user's shoe to maintain tension in said belt and control slack.

10. The scooter of claim 8 wherein said at least one foot-supporting belt is provided with a small-diameter wheel disposed at the heel end of a user's shoe to maintain tension in said belt and control slack.

11. The scooter of claim 1 wherein said scooter frame comprises a two-wheeled chassis.

12. The scooter of claim 1 wherein said scooter frame comprises a four-wheeled chassis.

13. The scooter of claim 1 wherein said at least one linking means is a link chain.

14. The scooter of claim 1 wherein said at least one linking means is a V-belt.

15. The scooter of claim 1 wherein said forward motion is produced by generating a drive pulse transmitted to said rear-drive wheel via said at least one linking means when an incremental lifting of the heel of a rider standing on said at least one foot-rest exerts foot pressure on said drive train.

16. The scooter of claim 15 wherein said forward motion is optimized when said foot pressure is applied as close as possible to the pressure vector in relation to a gravitational vector.

17. The scooter of claim 1 wherein said overrunning clutch provides said forward motion when engaged in one direction and only freewheels in the other direction.

18. The scooter of claim 1 wherein said controlled timing of said weight vector-wheel affects a change in the speed of travel and power of motion of said scooter.

19. The scooter of claim 1 wherein said at least one return tension means comprises at least one of a return spring and a tension wheel.

20. The scooter of claim 1 wherein said scooter is constructed of a lightweight material selected from the group comprising: plastic, aluminum, and leather.
